(19) United States
(12) Patent Application Publication
(10) Pub. No.: US 2026/0180340 A1
(43) Pub. Date: Jun. 25, 2026

(54) IMPROVED SYSTEM FOR SUPPLYING POWER TO AN AIRCRAFT

(71) Applicants: AIRBUS OPERATIONS SAS, Toulouse (FR); AIRBUS OPERATIONS SL, Getafe (ES)

(72) Inventors: Gabrielle Joséphine Christiane DE BROUWER, Getafe (ES); Franck ALBERO, Toulouse (FR)

(73) Assignees: AIRBUS OPERATIONS SAS, Toulouse (FR); AIRBUS OPERATIONS SL, Getafe (ES)

(21) Appl. No.: 19/423,812

(22) Filed: Dec. 17, 2025

(30) Foreign Application Priority Data
Dec. 24, 2024 (FR) 2415215

(51) Int. Cl. H02J 4/20; B64D 27/357; B64D 27/359

(52) U.S. Cl. CPC H02J 4/20; B64D 27/357; B64D 27/359

(57) ABSTRACT

A power supply system, of an aircraft, configured to supply electrical energy to on-board electrical devices including at least an electrical sub-circuit of the high-voltage DC type, an electrical sub-circuit of the low-voltage AC type, and an electrical sub-circuit of the low-voltage DC type. The system additionally including a high-voltage battery switching circuit, the system being such that every power supply line of said low-voltage DC sub-circuit, which power supply line is independent of said switching circuit, has no low-voltage battery. Advantageously, it is thus possible to avoid battery redundancy that is detrimental to the weight of the aircraft and leads to its electrical system being complex.

### TECHNICAL FIELD

The present invention relates to an improved system for supplying power to an aircraft comprising in particular high-voltage DC electrical circuits and batteries.

### PRIOR ART

Aircraft architectures are evolving, in particular with the aim of substantially reducing carbon gas emissions. Recent or forthcoming architectures are therefore more electrified and the electrical energy density required on board aircraft is much higher, on the ground and in flight. This evolution is leading to the use of electrical circuits of the high-voltage DC type comprising high-voltage DC batteries which are able to supply high current density and to supply power to numerous elements of a hybrid or electric aircraft, including electrical powertrains for example. Numerous aircraft electrical circuits, other than high-voltage DC circuits, have remained consistent, in whole or in part, with standard electrical system architectures, which results in a certain redundancy in the usage of battery-type electrical energy storage units. Such a redundancy is therefore detrimental in terms of industrialization, weight, cost, maintenance and, more globally, complexity of the aircraft systems involved.

The situation can be improved.

### SUMMARY OF THE INVENTION

An object of the present invention is to propose an improved arrangement of an aircraft electrical system that makes it possible to overcome at least some of the drawbacks of the prior art, in particular by avoiding redundancy of battery usage, which is detrimental in particular to weight and to the simplicity of the systems.

To this end, a power supply system, of an aircraft, configured to supply electrical energy to on-board electrical devices in the aircraft is proposed, the system comprising at least:
a first electrical sub-circuit of the high-voltage DC type comprising one or more high-voltage DC batteries,
a second electrical sub-circuit of the low-voltage AC type powered from said first electrical sub-circuit via one or more first electrical power converters, and,
a third electrical sub-circuit of the low-voltage DC type, powered, by the second sub-circuit, via one or more second electrical power converters,
a battery switching circuit, in the system, of the high-voltage battery or batteries,
the power supply system being such that every power supply line of the third sub-circuit, which power supply line is independent of said switching circuit, has no low-voltage battery.

It is thus advantageously possible to dispense with the use of redundant low-voltage batteries and instead use high-voltage DC batteries since the latter are capable of supplying the electrical energy previously provided by the low-voltage DC batteries.

The power supply system according to the invention may comprise the following additional features considered alone or in combination:
The third electrical sub-circuit comprises one or more supercapacitor-type components.
The power supply system comprises a connection socket configured for connection to an energy source external to said aircraft, possibly in one of the aforementioned sub-circuits.
The first electrical sub-circuit is configured to deliver a DC voltage greater than 300 V, the second electrical sub-circuit is configured to deliver an AC voltage equal to 115 V and the third electrical sub-circuit is configured to deliver a voltage of less than 50 V.

Another subject of the invention is an aircraft comprising a power supply system as described previously.

### BRIEF DESCRIPTION OF THE DRAWINGS

FIG. 1 schematically illustrates an aircraft power supply system according to one embodiment; and,

FIG. 2 schematically illustrates an aircraft comprising a power supply system as already shown in FIG. 1.

### DETAILED DESCRIPTION OF THE EMBODIMENTS

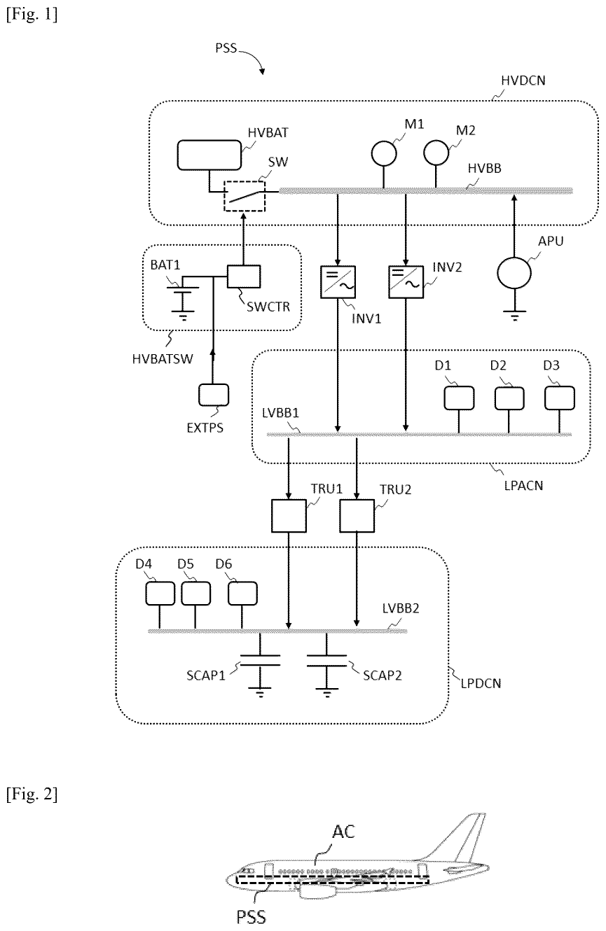

FIG. 1 schematically shows an aircraft power supply system PSS according to one embodiment. The system PSS is an aircraft power supply system in the sense that it is intended to supply electrical energy to electrical devices on board the aircraft in which it is installed. According to the example described, the system PSS comprises an electrical sub-circuit HVDCN of the high-voltage DC type that comprises a high-voltage DC battery HVBAT configured to supply electrical energy via a first power supply bus HVBB. According to one embodiment, the battery HVBAT is an assembly of high-voltage DC batteries. The power supply system PSS also comprises an electrical sub-circuit LPACN of the low-voltage AC type powered from the electrical sub-circuit HVDCN, via one or more first electrical power converters. According to the exemplary embodiment illustrated in FIG. 1, two inverter-type power converters INV1 and INV2 are configured to generate a low DC voltage from the electrical network LPACN, and to supply this voltage via a second power supply bus LVBB1. The power supply system PSS also comprises an electrical sub-circuit LPDCN of the low-voltage DC type, powered, by said sub-circuit LPACN, via one or more second electrical power converters. According to the exemplary embodiment illustrated in FIG. 1, two rectifier transformer-type power converters TRU1 and TRU2 are configured to generate a low DC voltage from the electrical network LPACN, and to supply this voltage via a third power supply bus LVBB2. The power supply system PSS additionally comprises an auxiliary power unit APU of the aircraft in which the system PSS is installed. The outlet of the auxiliary power unit APU is connected to the first supply bus HVBB. The system PSS additionally comprises a battery switching circuit HVBATSW configured to perform switching or isolation, in the system PSS, of the high-voltage battery or batteries HVBAT, via a switch SW and under the control of a control device SWCTR. According to one embodiment, the battery switching circuit HVBATSW comprises a battery BAT1 configured to supply power to the battery switching circuit HVBATSW. The battery BAT1 may be, for example, a high-voltage battery of the high-voltage DC sub-circuit HVDCN or a low-voltage battery of the low-voltage DC sub-circuit LPDCN.

The power supply system PSS arranged in this way makes it possible simultaneously to supply power to electrical elements or devices that require a high DC voltage, such as, by way of examples, aircraft powertrains M1 and M2 which are connected to the power supply bus HVBB, and electrical elements or devices that require a low AC voltage, such as electrical devices D1, D2 and D3 which are connected to the power supply bus LVBB1 and electrical elements or devices that require a low DC voltage, such as electrical devices D4, D5 and D6 which are connected to the power supply bus LVBB2. Here, the term “electrical device” denotes any device that requires a power supply in order to operate at least in some circumstances. Therefore, this term equally denotes a purely electrical device, an electromechanical device, a hydroelectrical device, an electropneumatic device, etc.

Ingeniously and advantageously, the power supply system PSS is configured and arranged such that every supply line of the low-voltage DC sub-circuit, which supply line is independent of the power supply to the switching circuit HVBATSW, has no battery.

According to one embodiment, the low-voltage DC sub-circuit of the power supply system PSS comprises one or more supercapacitors which are configured to store electrical energy. According to the example described, two supercapacitors SCAP1 and SCAP2 are connected to the low-voltage DC power supply bus LVBB2 and are dimensioned to be able to power the sub-circuit LPDCN for a predetermined power duration.

According to embodiment variants, the battery BAT1 may be fitted in other areas of the power supply system PSS as long as it is then able to supply power to at least the switching circuit HVBATSW for the high-voltage battery/batteries.

According to one embodiment, the power supply system PSS comprises a supply connection or socket EXTPS for a power supply source that is external to the aircraft and connected to the switching circuit HVBATSW and it is thus possible to dispense with the battery BAT1 for supplying power to the switching circuit HVBATSW for the purpose of switching the battery HVBAT in the sub-circuit HVDCN.

According to one embodiment, the low-voltage DC sub-circuit LPDCN is a circuit that is intended to be normally operational during all the flight phases of an aircraft in which it is installed and another low-voltage DC, emergency, sub-circuit may be implemented in this aircraft.

According to one embodiment, the low-voltage DC sub-circuit LPDCN is a circuit that is intended to be operational in predefined urgent situations in flight or on the ground and another low-voltage DC sub-circuit, which is able to operate during all the other flight phases, is implemented in the aircraft. Predefined urgent situations may be, by way of non-limiting examples, a plane evacuation phase, a situation in which one or more elements fail, etc.

According to one embodiment, the electrical sub-circuit HVDCN is configured to deliver a DC voltage greater than 300 V, the electrical sub-circuit LPACN is configured to deliver an AC voltage equal to 115 V and the low-voltage DC electrical sub-circuit LPDCN is configured to deliver a voltage of less than 50 V.

According to one embodiment, the electrical sub-circuit HVDCN is configured to deliver a DC voltage equal to 540 or 800 V and the low-voltage DC electrical sub-circuit LPDCN is configured to deliver a voltage equal to 28 V.

FIG. 2 schematically illustrates an aircraft AC advantageously comprising the power supply system PSS described above, which makes it possible to obtain a saving with respect to weight, cost, architectural simplicity and logistics of use and maintenance.

The invention is not limited to just the examples and embodiments described, but is applicable more generally to any aircraft power supply system comprising a low-voltage DC power supply circuit in which every supply line of this sub-circuit, which supply line is independent of a high-voltage DC battery switching circuit, has no battery.

1. A power supply system of an aircraft configured to supply electrical energy to on-board electrical devices in said aircraft, said system comprising:
a first electrical sub-circuit of the high-voltage DC type comprising one or more high-voltage DC batteries,
a second electrical sub-circuit of the low-voltage AC type powered from said first electrical sub-circuit via one or more first electrical power converters,
a third electrical sub-circuit of the low-voltage DC type, powered, by said second sub-circuit, via one or more second electrical power converters, and
a battery switching circuit of said high-voltage battery or batteries, wherein every power supply line of said third sub-circuit, which power supply line is independent of said switching circuit, has no battery.

2. The power supply system according to claim 1, in which said third electrical sub-circuit comprises one or more supercapacitor-type components.

3. The power supply system according to claim 1, in which said first electrical sub-circuit comprises a connection socket configured for connection to an energy source external to said aircraft and configured to power said switching circuit.

4. The power supply system according to claim 1, in which the first electrical sub-circuit is configured to deliver a DC voltage greater than 300 V, the second electrical sub-circuit is configured to deliver an AC voltage equal to 115 V and the third electrical sub-circuit is configured to deliver a voltage of less than 50 V.

5. The aircraft comprising a power supply system according to claim 1.
